(19) United States
(12) Patent Application Publication
(10) Pub. No.: US 2015/0381542 A1
(43) Pub. Date: Dec. 31, 2015

(54) SYSTEMS AND METHODS FOR SCHEDULED DELIVERY OF CONTENT

(71) Applicant: BARTLEBY GROUP, LLC., Austin, TX (US)

(72) Inventors: SHILOH COLEMAN, Austin, TX (US); MITCHELL RIECHMANN, Austin, TX (US)

(21) Appl. No.: 14/319,536

(22) Filed: Jun. 30, 2014

(51) Int. Cl. H04L 12/58; H04L 29/08

(52) U.S. Cl. CPC H04L 51/18; H04L 67/1095

(57) ABSTRACT

Systems and methods for asynchronously delivering content to a recipient include receiving a recipient identifier and an item of content from a sender device, generating a unique redemption code associated with the recipient identifier, and storing the content, identifier, and redemption code in a data storage medium. The unique redemption code can be output to the sending device. At a later time, the unique redemption code can be received from a recipient device, delivery information can be requested from the recipient device, and the delivery information can be received and stored. The delivery information can be used to provide the content to the recipient device in the scheduled manner determined by the sender.

### FIELD

Embodiments usable within the scope of the present disclosure relate, generally, to systems and methods for asynchronously transmitting content to a recipient device, and more specifically, to systems and methods usable to schedule future delivery of content to a recipient, e.g., by contemporaneously receiving delivery information relating to the recipient at a later time and/or date than the date at which the content was initially prepared.

### BACKGROUND

Conventional methods for transmitting information, methods, images, videos, audio recordings, and/or other types of content (e.g., via the internet or other types of network) allow content to be received by a party nearly instantly, limited only by the capabilities of the network and/or other equipment used to transmit the content and/or by the size/nature of the content. However, under certain circumstances, a sender may desire to prepare information for future transmission to a recipient. For example, an individual may choose to prepare messages, images, videos, or other types of information, contact information for a recipient (e.g., a recipient's current address, e-mail address, telephone number, etc.), and provide a future date or time at which this information will automatically be delivered to a recipient. One shortcoming of such methods involves the changeability of the recipient's contact information; if the recipient relocates and/or ceases to use an existing e-mail address or telephone number, and the sender is unaware of this fact and/or unable to readily acquire the recipient's updated contact information, the content may never reach the recipient.

In certain occasions, a sender may desire to transmit content to a recipient at an unknown and/or variable future time, such as following an unexpected event. For example, a sender may wish to prepare a message for receipt by his or her loved ones in the event of his or her death, but understandably would not wish for this message to be delivered until after the sender's death—an event that will occur at an unknown date and time in the future. Even if some manner of future delivery of content, triggered by a sender's death, could be scheduled, such an event may occur years in the future, creating a strong likelihood that the current contact information of one or more recipients may cease to be valid prior to delivery of the content. Furthermore, when planning delivery of content in the event of a death or other significant future event, a sender may desire to communicate content to parties not in existence yet, e.g., unborn and/or future children or other relatives, for which contact/delivery information would not exist until a future time.

A need exists for systems and methods usable to deliver content to recipients at an unknown and/or variable future time, when the contact information of recipients at that future time is not known.

### SUMMARY

Embodiments usable within the scope of the present disclosure include systems and computer-implemented methods usable to asynchronously deliver content (e.g., from a sender) to one or more recipients. For example, a web-based application, e.g., hosted on a server or a similar non-transitory data storage medium, in communication with the internet and/or other types of networks, can be accessed by various devices (e.g., sender and recipient devices) to facilitate transmission of content and execution of various procedures (e.g., using a processor associated with the data storage medium).

For each desired recipient, a recipient identifier (e.g., a first and last name, or any other text, string, or other data usable to differentiate an individual recipient from other individuals, such as for individuals not yet born or other individuals not known by name, etc.) and one or more items of content (e.g., textual messages, images, videos, audio recordings, or any other type of data) can be received from a sending device. A unique redemption code associated with the recipient identifier can then be identified, and the item(s) of content and the recipient identifier can be stored in association with the unique redemption code. While usable unique redemption codes can include any manner of standardized and/or randomized data, in an embodiment, a portion of the redemption code can include information corresponding to the recipient identifier and/or an identifier of the sender. For example, a redemption code could include the initials of the sender, followed by the initials of the recipient, followed by a randomly-generated alphanumeric string (e.g., eight characters). The unique redemption code for each recipient can then be output to the sending device.

As such, the information received from the sender device may not necessarily include information sufficient to deliver the content to one or more of the desired recipients, nor information regarding the specific date and/or time at which the content is to be delivered. Instead, in an embodiment, only the content, itself, and some manner of identifier for the recipient can be provided, for storage in association with a unique redemption code specific to that recipient identifier and/or content. After generation of the unique redemption code, the code could potentially be provided to one or more desired recipients through means external to the present systems and methods. For example, a sender could communicate a unique redemption code to a recipient with instructions that the code should not be redeemed until after the death of the sender, a sender could include one or more redemption codes in his or her will, or any other means of providing redemption codes to recipients could be used.

At a future time (e.g., after the death of the sender), the unique redemption code can be received from a recipient device. Responsive to the receipt of the redemption code, a request for delivery information (e.g., contact information sufficient to transmit the item(s) of content) can be provided to the recipient device, and delivery information can be received therefrom (e.g., and stored in association with the recipient identifier). The one or more items of content can then be transmitted to the recipient device using the delivery information (e.g., an e-mail address, a telephone number, cellular service provider, account information relating to a social media platform, etc.) In the event that a recipient has accessed the system previously, in various embodiments, the system can include an account feature, such that a recipient can log into a preexisting account (e.g., having delivery information associated therewith), and redeem a unique redemption code via this account, thereby allowing the item(s) of content to be transmitted to the delivery information associated with the recipient's account. As such, in an embodiment, a single recipient could receive multiple redemption codes (e.g., from multiple senders), while providing delivery information to the system only once.

In an embodiment, a feature usable to prevent premature redemption of a unique redemption code can be present. For example, upon receipt of a unique redemption code from a recipient device, a notification of this receipt can be transmitted to the sending device, and transmission of the item(s) of content can be delayed for a period of time (e.g., 48 hours, or another selected time period). If, during this period of time, a cancellation request is received from the sender device, transmission of the content can be cancelled. If, instead, a confirmation is received from the sender device and/or if no response is received from the sender device and the time period lapses, the item(s) of content can be transmit to the recipient device.

In an embodiment, a scheduling feature can be included, by which a sender device can enable transmission of multiple items of content to one or more recipients, each item of content (or groupings of items of content) being delivered at a different time. Alternatively, a single item of content could be scheduled for transmission at a selected time (e.g., after the expiration of a preselected time period following receipt of the redemption code). For example, in addition to recipient identifiers and items of content to be delivered, one or more delivery time periods can be received from the sender device, each delivery time period being associated with a respective item of content (or a multiple items of content). After receipt of a unique redemption code, the respective delivery time period(s) can begin to toll, and after expiration of each time period, the corresponding item of content can be transmitted to the recipient device. Using such a feature, a sender could, for example, transmit a single item of content a selected amount of time after receipt of the redemption code, or sequentially transmit multiple items at different time periods (hourly, daily, weekly, or at any other regular or irregular schedule of delivery).

In an embodiment, updated delivery information can be received from a recipient device, e.g., after transmission of one or more items of content thereto, but before transmission of one or more subsequent items of content.

Embodiments usable within the scope of the present disclosure thereby enable the asynchronous delivery of content, from a sender to a recipient, at an indefinite future time, when delivery information that will be sufficient to deliver the content at that time is not known, by generating a unique redemption code that can be “redeemed” in the future, to enable a recipient to input delivery information for receiving items of content.

### BRIEF DESCRIPTION OF THE DRAWINGS

In the detailed description of various embodiments usable within the scope of the present disclosure, presented below, reference is made to the accompanying drawings, in which:

FIG. 1 depicts a diagram of an embodiment of a system usable within the scope of the present disclosure.

FIG. 2 depicts a diagram of an embodiment of a method usable within the scope of the present disclosure.

One or more embodiments are described below with reference to the listed Figures.

### DETAILED DESCRIPTION OF THE EMBODIMENTS

Before describing selected embodiments of the present invention in detail, it is to be understood that the present invention is not limited to the particular embodiments described herein. The disclosure and description herein is illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended to illustrate and plainly disclose presently preferred embodiments of the invention to one of skill in the art, but are not intended to be manufacturing level drawings or renditions of final products and may include simplified conceptual views as desired for easier and quicker understanding or explanation of the invention. As well, the relative size and arrangement of the components may differ from that shown and still operate within the spirit of the invention as described throughout the present application.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

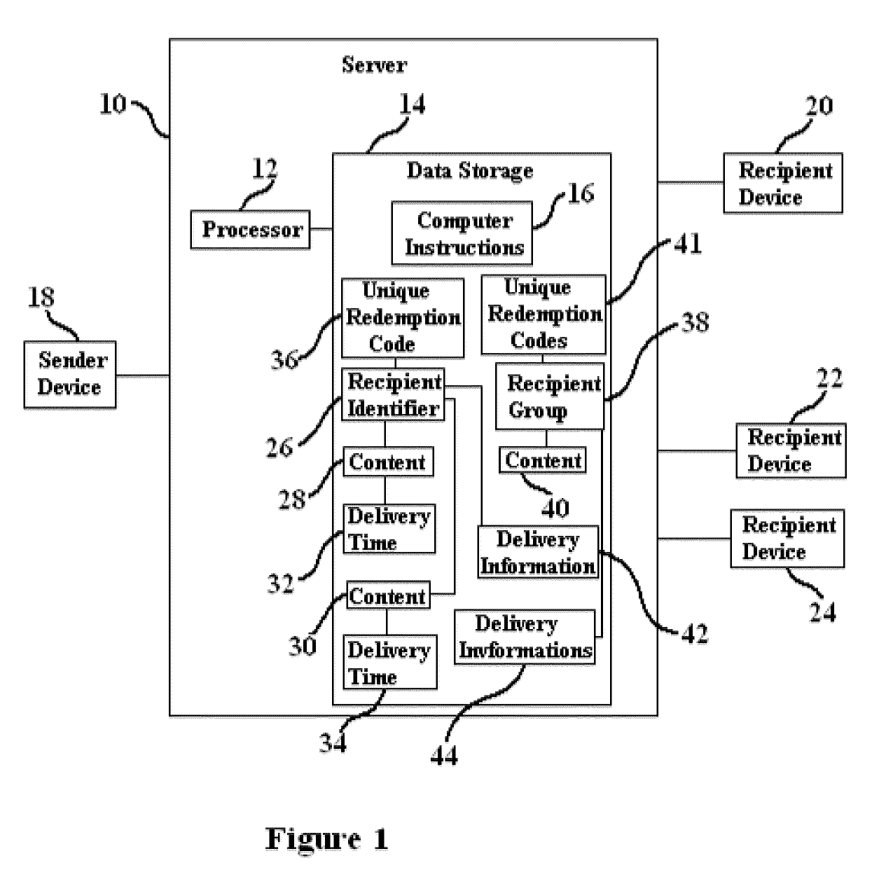

FIG. 1 depicts a diagram of an embodiment of a system usable within the scope of the present disclosure. The depicted embodiment includes a processor (12) and a non-transitory data storage medium (14), integrated within a server (10). Computer instructions (16) are shown within the data storage medium (14), the depicted computer instructions (16) being representative of any software, code, modules, applications, etc., usable to perform one or more embodied processes described herein. It should be understood that the integration of each of the system components within the server (10) is one exemplary embodiment; however, in various embodiments, one or more processors separate and/or remote from one or more data storage media could be used without departing from the scope of the present disclosure. For example, computer instructions (16) and one or more items of data usable to perform one or more embodied processes could be stored on the device of a sending and/or receiving user without departing from the scope of the present disclosure. In brief summary, any combination of processors, data storage media, and/or computer instructions, remote or local, can be used, in combination with any number and type of input and/or output devices, limited only by the technological capabilities of the components used.

A sender device (18) and three recipient devices (20, 22, 24) are shown in association with the server (10) (e.g., in communication therewith via the internet, one or more networks, a direct connection, etc.). The sender and recipient devices (18, 20, 22, 24) can include any type of device having input and output components, such as a computer, a cellular telephone, a tablet, or any other similar type of device. While the sender and recipient devices (18, 20, 22, 24) can include processors and/or data storage media associated therewith, it should be understood that embodiments usable within the scope of the present disclosure could be performed using input and output devices that rely on the processor (12) and data storage medium (14) of the server (10), or the server (10) itself could be directly accessed by one or more senders and/or recipients and could function as the depicted sender and/or recipient devices (18, 20, 22, 24).

In the depicted embodiment, the sender device (18) can be used to transmit a first recipient identifier (26) (e.g., a name or any other string or item of data usable to differentiate one intended recipient of content from other recipients) to the server (10), along with one or more items of content (28, 30) (e.g., textual messages, images, videos, audio recordings, or any other type of data) intended for future delivery to a recipient associated with the recipient identifier (26). In the example shown in FIG. 1, two items of content (28, 30) are provided for association with the recipient identifier (26). The sender device (18) can also be used to transmit a first delivery time period (32) associated with the first item of content (28) and a second delivery time period (34) associated with the second item of content (30). The items of content (28, 30) and respective delivery time periods (32, 34) can be stored in the data storage medium (14) in association with the recipient identifier (26), and the processor (12), in association with the computer instructions (16), can be used to generate a unique redemption code (36), also stored in association with the recipient identifier (26).

In the depicted embodiment, the sender device (18) can also be used to transmit a recipient group (38) to the server (10). Creation of a “recipient group” as used herein can include transmission of multiple recipient identifiers (which can include the recipient identifier (26) and/or other identifiers associated with other recipients) to the server (10) by the sender device (18), with each recipient identifier that is a member of the recipient group (38) being categorized, flagged, tagged, and/or otherwise indicated to be members of a grouping, category, classification, etc., of recipients, to facilitate the transmission of content by a sender to multiple recipients, e.g., by allowing the sender to identify a recipient group in lieu of individually identifying each recipient identifier that is associated with the recipient group (38). One or more items of content (40) can also be provided by the sender device (18) to be associated with the recipient group (38). In the exemplary embodiment shown in FIG. 1, no delivery time (such as delivery times (30, 32)) is shown associated with the item of content (40), and as such, in the depicted example, the item of content (40) could be delivered immediately after an associated redemption code is redeemed (or after a cancellation/confirmation period has expired, as described above), without allowing any delivery time period to lapse. Alternatively, in an embodiment, a default delivery time period could be applied to one or more items of content for which no delivery time period is specified. The processor (12), in association with the computer instructions (16), can be used to generate a plurality of unique redemption codes (41), each of which is associated with a recipient identifier of the recipient group (38).

It should be understood that while FIG. 1 depicts items of content associated with each recipient identifier, in various embodiments, a sender device can be used to generate one or more recipient identifiers with no items of content associated therewith (e.g., to allow for the future transmission of content for storage in association with one or more of the recipient identifiers). In such cases, a unique redemption code associated with each recipient identifier can be generated, even in the absence of any items of content associated therewith, and a sender could, if desired, transmit content at a later time. However, even in the absence of any items of content, a unique redemption code could still be used by a recipient device to access the system, e.g., to determine that no items of content are currently accessible by that recipient.

The unique redemption codes (36, 41) stored in the data storage medium (14) can be output to the sender device (18), e.g., to enable a sender to provide the unique redemption codes (36, 41) to one or more recipients. The specific manner in which the unique redemption codes (36, 41) are provided to intended recipients can occur external to the depicted system. For example, a sender could personally provide the unique redemption codes (36, 41) to intended recipients of the content (26, 28, 40) and/or other individuals associated therewith, the sender could store and/or otherwise retain the unique redemption codes (36, 41) securely until a future time, the sender could include the unique redemption codes (36, 41) as part of his or her will, or the sender could decide at a future time that it is no longer desired to deliver certain content to certain recipients and refrain from communicating one or more of the unique redemption codes (36, 41) to others.

At a future time, one or more of the recipient devices (20, 22, 24) can be used to transmit unique redemption codes (36, 41) to the server (10). It should be understood that the information provided to the server (10) by the sender device (18) (e.g., the recipient identifiers (26, 38), content (28, 30, 40), and delivery times (32, 34)) may be insufficient to deliver the items of content (28, 30, 40) to any specific recipient and/or device. In lieu of receiving delivery information relating to one or more recipients at the time that the content (28, 30, 40) is provided to the server (10), the processor (12) can be used to generate unique redemption codes (36, 41) that can later be received from the one or more recipient devices (20, 22, 24). Subsequent to receipt of the unique redemption codes (36, 41), a request for delivery information can be provided to the recipient devices (20, 22, 24), and associated delivery information can be received therefrom. FIG. 1 depicts a first set of delivery information (42), received from the first recipient device (20), which can be stored in association with the first recipient identifier (26), and a second set of delivery informations (44) (representative of multiple sets of delivery information), which can be received from multiple recipient devices (22, 24) responsive to entry of respective unique redemption codes (41) and subsequent requests for delivery information.

The delivery information (42, 44) can include, for example, e-mail addresses, telephone numbers, contact information relating to a social media platform, or any other information usable to transmit the items of content (28, 30, 40) to the recipient devices (20, 22, 24) and/or otherwise make the content (28, 30, 40) accessible thereto. In the depicted embodiment, the third item of content (40) can be delivered to the second and third recipient devices (22, 24) immediately after and/or proximate to the receipt of the delivery informations (44) therefrom (since no delivery time period was provided by the sender device (18) for association with the item of content (40)). The first item of content (28) can be delivered to the first recipient device (20) after expiration of the first delivery time period (32), and the second item of content (30) can be delivered after expiration of the second delivery time period (34). As such, the depicted system can enable the content (28, 30, 40) to be uploaded and/or otherwise input by the sender device (18) at a first time, and to be transmitted to one or more recipient devices (20, 22, 24) at an unspecified future time that is determined by the time at which the unique redemption codes (36, 41) are received from one or more recipient devices.

As described previously, while delivery information can be collected from recipient devices upon receipt of unique redemption codes therefrom, in various embodiments, the system can include an account feature in which delivery information can be stored in association with a recipient identifier and/or other recipient account information. In such an embodiment, a recipient could access his or her account, and a recipient device could be used to transmit a unique redemption code. Responsive to receipt of the code, the system could then transmit one or more items of content to the recipient device using the delivery information already associated with the recipient's account. An account feature can facilitate, for example, a single recipient receiving multiple unique redemption codes, e.g., from multiple senders.

In an embodiment, after receipt of the unique redemption codes (36, 41) and/or receipt of the delivery information (42, 44), a notification can be sent to the sender device (18) and a cancellation/confirmation period can be initiated. If no cancellation request is received from the sender device (18) during the cancellation/confirmation period, and/or if a confirmation is received, the delivery time periods (32, 34) can be initiated, and/or content can be transmitted immediately if no delivery time period is associated therewith. The sender device (18) can thereby be used to schedule future delivery of content (28, 30, 40) to one or more recipient devices (20, 22, 24), at an unspecified future time, without supplying delivery information to the server (10) at the time the content (28, 30, 40) is provided thereto.

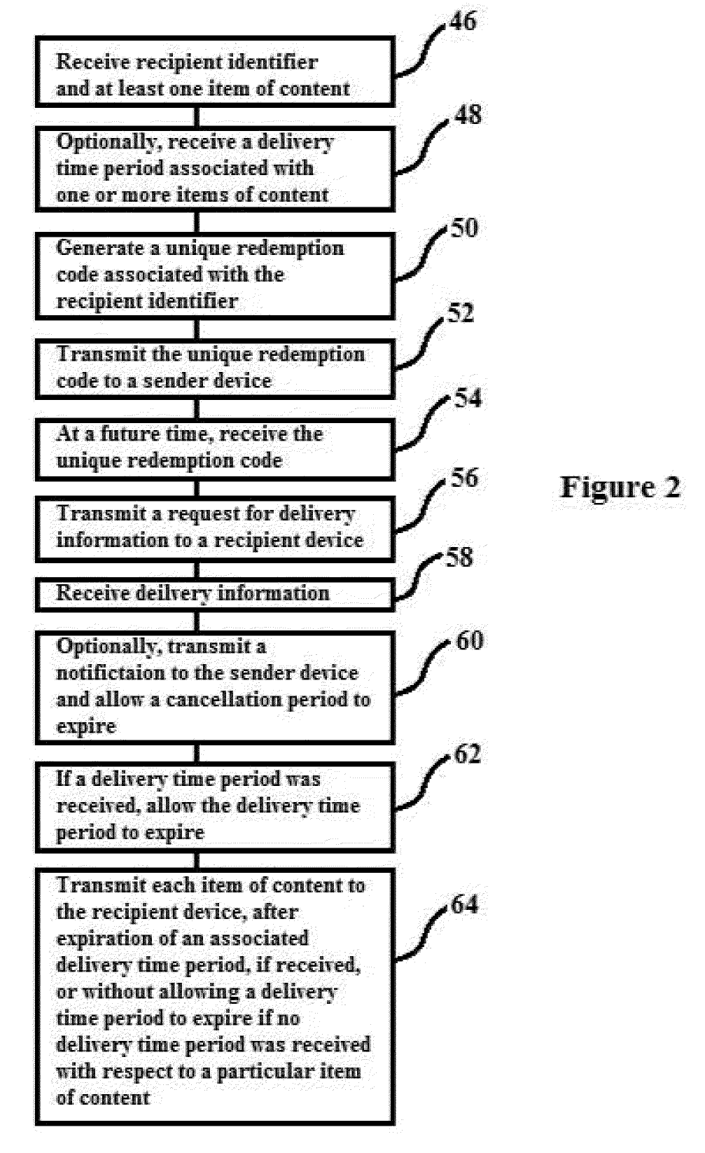

FIG. 2 depicts a diagram illustrating an embodiment of a method usable within the scope of the present disclosure. Initially, a recipient identifier and at least one item of content are received (46), e.g., from a sender device. However, as described above, in various embodiments, a recipient identifier could be received without any content associated therewith; a unique redemption code could be generated and transmitted to the sender device, and later redeemed in the absence of any associated content, and/or a sender device could provide one or more items of content at a later date/time. For example, a sender device can be used to create an account that can be stored in association with any recipient identifiers and/or content received therefrom. Typically, creation of a sender account can include receipt of a sender and/or account name, an e-mail address and/or telephone number associated with the sender, and a password or other security and/or access feature; however, it should be understood that an account could include little more than a unique string of data (e.g., a name or other textual string) provided by the sender and/or generated by the system to differentiate received materials associated with one sender device from materials associated with other devices. The recipient identifier can include any data usable to differentiate one recipient identifier from other identifiers; for example, the recipient identifier can include a recipient's first and last name. In an embodiment, a sender can also input a type of relationship (e.g., using a drop-down menu) to indicate the relationship between the sender and an intended recipient (e.g., friend, father, mother, grandparent, uncle, aunt, cousin, etc.) At the time that a recipient identifier is received, a sender device could also be used to indicate whether that particular recipient identifier is classified as part of a group of recipients. Items of content can thereby be prepared for transmission to multiple recipients easily, e.g., by enabling the sender to select a group of recipients for receipt in lieu of or in addition to selecting multiple individual recipients.

Optionally, a delivery time period can be received in association with one or more items of content (48). As described above, a delivery time period can be input, e.g., by a sender device, to delay transmission of one or more items of content to one or more recipient devices, thereby enabling senders to schedule items of content for immediate, delayed, and/or sequential delivery to recipients. If no delivery time period is received in association with a particular item of content, that item of content can be transmitted to a recipient device without allowing expiration of an associated time period (e.g., by setting the delivery time period to zero as a default), or alternatively, the system can apply a default time period (e.g., 24 hours, 48 hours, etc.) to any item of content for which no delivery time period is received.

After receipt of a recipient identifier and one or more items of content associated therewith, a unique redemption code associated with the recipient identifier can be generated (50). As described above, in an embodiment, the unique redemption code can include a portion corresponding to the recipient identifier and/or an identifier of the sender, e.g., to facilitate visual differentiation between multiple redemption codes by a sender and/or to indicate the pertinence of a redemption code to one or more recipients. For example, a redemption code could include the initials of the sender, followed by the initials of the recipient, followed by a randomly-generated alphanumeric string (e.g., eight characters). After generation thereof, the unique redemption code can be transmitted to the sender device (52). In an embodiment, the unique redemption code can be provided to the sender device in the form of pre-formatted content. For example, the redemption code can include a link (e.g., a “PDF icon” or a similar feature) that can be accessed to generate a formatted letter containing the unique redemption code and instructions to an intended recipient describing how to access the system to redeem the code.

As described previously, any unique redemption codes generated using embodiments of the present system can be communicated to intended recipients (e.g., by a sender) external from the system. As such, the information relating to a recipient (e.g., a recipient identifier) need not include any information usable to contact and/or communicate with the recipient. Further, any administrators, operators, owners, etc. of the present system can remain unassociated with any recipients until contacted, at a future time, via receipt of a unique redemption code, thereby insulating recipients from potentially undesired contact while insulating any administrators, operators, and/or owners, of the system from responsibility and/or liability relating to communication of unique redemption codes and/or other content. In an embodiment, unique redemption codes can remain accessible to senders, e.g., via accessing an account associated with the system, to prevent unintended loss of such codes by senders. For example, if a recipient does not desire to receive any content provided by the sender, a recipient can simply refrain from accessing the system and transmitting the redemption code thereto. In an embodiment, the recipient can be permitted to accept or reject individual items of content, e.g., after transmission of the redemption code to the system.

At a future time, a unique redemption code can be received (54), e.g., from a recipient device. For example, a device can be used to access the system (e.g., by accessing a web page over the internet, or other similar means), and the unique redemption code can be entered, such as by typing the code in a field. Responsive to receipt of the redemption code, a request for delivery information can be transmit to the recipient device (56). For example, the recipient can be prompted to create an account, such as by providing a name, password, e-mail address, telephone number, and/or other contact information and/or demographic information. In various embodiments, however, creation of an account can be unnecessary, and a recipient can simply provide delivery information sufficient to transmit content to the recipient device. Responsive to transmission requesting delivery information, delivery information can be received (58), e.g., from the recipient device. Because it may be possible for a sender to schedule one or more items of content for delivery at a time later than that which the recipient device transmits a unique redemption code and provides delivery information, a recipient device can be permitted to access the system at future times to add and/or modify delivery information. In an embodiment, the system can provide one or more reminders regarding maintaining and/or updating the delivery information.

As described above, once a recipient account has been created, it may be possible for a recipient device to access the account and transmit one or more unique redemption codes while bypassing the entry of delivery information and/or other account information; the item(s) of content associated with the unique redemption code(s) could simply be transmitted to the delivery information already associated with the recipient account.

At any time after receipt of the unique redemption code, but prior to the transmission of any content to a recipient device (e.g., after step (54), but before step (64)), a notification can be transmitted to the sender device and a cancellation period can be allowed to expire (60). This feature can be present to prevent premature transmission of content to one or more recipients. In an embodiment, a sender could select (e.g., via an account setting and/or in connection with individual recipients and/or items of content) whether a cancellation period is initiated. For example, a sender could provide a unique redemption code to a recipient, with instructions that the code was not to be redeemed until the death of the sender. If the unique redemption code is received prior to the death of the sender, either intentionally or due to mistake, a notification could be transmit to the sender device indicating receipt of the redemption code. The sender device could then be used to transmit a cancellation request prior to the expiration of the cancellation period. For example, in an embodiment, the notification provided to the sender device could include an e-mail or text message having a link or button that could be selected to cancel transmission of content. If no cancellation request is transmitted, the cancellation period is allowed to expire, and/or if no cancellation time period is utilized, the embodied method can continue as illustrated in FIG. 2. In an embodiment, the sender device could be used to cancel subsequent transmission of content even after expiration of a cancellation period. For example, after receipt of a unique redemption code, a notification can be transmitted to a sender device, the cancellation period can be allowed to expire, and one or more items of content can be transmitted to the recipient device; however, a cancellation request could subsequently be received from the sender device, and transmission of any future items of content scheduled for delivery to the recipient device associated with the received redemption code could be cancelled.

After expiration of a cancellation period, if such a feature is utilized, a delivery time period, if received, can be initiated and allowed to expire (62). If no delivery time period is received (e.g., during step (48)), this step can be omitted, or as described above, in various embodiments, a default delivery time period can be allowed to expire.

Each item of content can then be transmitted to the corresponding recipient device, after expiration of an associated delivery time period (if received), or without allowing a delivery time period to expire (if no delivery time period was received), with respect to a particular item of content (64). Transmission of content to a recipient can include various and/or multiple means of transmission, e.g., depending on the nature of the content. For example, content could be communicated to a cellular telephone (e.g., a text message or other type of content via a cellular telephone number), to an e-mail address (e.g., a text message, an image, a video, an audio recording etc.), to a social media platform, or combinations thereof. In an embodiment, a notification could be transmit to a recipient device in lieu of an item of content. For example, the recipient device could receive a notification requesting that the recipient device access the system to view and/or download an item of content for remote or local viewing and/or playback. In an embodiment, for types of content capable of receipt via multiple means of communication, the sender and/or the recipient can select a preferred means of communication. In various embodiments, because delivery information is received from a recipient at a point in time that could potentially be much later than the time at which the content is initially transmit to the system, content could be transmit to a recipient device using technologies and/or media not available at the time when the content was originally received from the sender device.

Embodiments usable within the scope of the present disclosure thereby provide systems and methods usable for the asynchronous delivery of content. As such, a sender can prepare information for transmission to one or more recipients, at a future time (including an unknown and/or variable future time, e.g., a time based on a triggering event, such as the death of the sender), using future delivery/contact information of the recipient that may not yet be known. Through use of a unique redemption code that can be provided, e.g., from the sender to a recipient, external to embodied systems, thereby insulating recipients from potentially undesired contact by system owners/administrators/operators and insulating system owners/administrators/operators from responsibility for establishing contact with recipients and/or providing redemption codes thereto, current delivery information from recipients can be obtained contemporaneously—at the time a code is redeemed, which can potentially be a future time long after the original preparation of the content by the sender. Content can thereby be delivered to recipients using current/modern technological platforms, at a schedule pre-set by a sender, in the sender's absence.

While various embodiments usable within the scope of the present disclosure have been described with emphasis, it should be understood that within the scope of the appended claims, the present invention can be practiced other than as specifically described herein.

What is claimed is:

1. A computer-implemented method for asynchronously delivering content to a recipient device, the method comprising:
receiving, from a sender device, a recipient identifier and an item of content;
generating a unique redemption code associated with the recipient identifier;
storing, in a non-transitory data storage medium, the item of content and the recipient identifier in association with the unique redemption code;
transmitting the unique redemption code to the sending device;
receiving, from the recipient device, the unique redemption code;
requesting and receiving delivery information from the recipient device; and
transmitting the item of content to the recipient device using the delivery information.

2. The method of claim 1, further comprising transmitting to the sender device a notification of receipt of the unique redemption code from the recipient device and delaying transmission of the item of content to the recipient device for a period of time.

3. The method of claim 2, further comprising receiving, from the sender device, a cancellation request during the period of time and cancelling transmission of the item of content to the recipient device.

4. The method of claim 2, further comprising receiving, from the sender device, a confirmation during the period of time or permitting the period of time to lapse and transmitting the item of content to the recipient device after receiving the confirmation or after lapse of the period of time.

5. The method of claim 1, further comprising receiving, from the sender device, a delivery time period associated with the item of content and storing the delivery time period in association with the item of content, the recipient identifier, and the unique redemption code, wherein transmitting the item of content to the recipient device comprises permitting the delivery time period to lapse prior to transmitting the item of content to the recipient device.

6. The method of claim 5, wherein the item of content comprises a plurality of items of content, wherein the delivery time period comprises a discrete delivery time period associated with each item of content, and wherein transmitting the item of content to the recipient device comprises sequentially transmitting each item of content to the recipient device after expiration of a discrete delivery time period associated therewith.

7. The method of claim 6, further comprising transmitting a first item of content to the recipient device using the delivery information, receiving updated delivery information from the recipient device, and transmitting a second item of content to the recipient device using the updated delivery information.

8. A system for asynchronously delivering content to a recipient, the system comprising:
a processor;
a non-transitory data storage medium in communication with the processor;
computer instructions in the non-transitory data storage medium, wherein the computer instructions instruct the processor to:
receive a recipient identifier and an item of content;
generate a unique redemption code associated with the recipient identifier;
store, in the non-transitory data storage medium, the item of content and the recipient identifier in association with the unique redemption code;
output the unique redemption code;
receive the unique redemption code;
request delivery information responsive to receipt of the unique redemption code;
receive the delivery information and store the delivery information in the non-transitory data storage medium in association with the unique redemption code; and
output the item of content using the delivery information.

9. The system of claim 8, wherein the computer instructions further instruct the processor to:
output a notification of receipt of the unique redemption code; and
delay output of the item of content for a period of time.

10. The system of claim 9, wherein the computer instructions further instruct the processor to:
receive a cancellation request during the period of time; and
cancel output of the item of content.

11. The system of claim 9, wherein the computer instructions further instruct the processor to:
output the item of content after expiration of the period of time;
receive a confirmation during the period of time and output the item of content after receiving the confirmation; or
combinations thereof.

12. The system of claim 8, wherein the computer instructions further instruct the processor to:
receive a delivery time period associated with the item of content;
store the delivery time period in association with the item of content, the recipient identifier, and the unique redemption code; and
after receiving the unique redemption code, permitting the delivery time period to lapse prior to outputting the item of content.

13. The system of claim 12, wherein the computer instructions instruct the processor to:
receive and store a plurality of items of content and a discrete delivery time period associated with each item of content; and
sequentially output each item of content after expiration of a respective discrete delivery time period associated therewith.

14. The system of claim 8, wherein the item of content comprises: a textual message, a video, an audio recording, an image, or combinations thereof.

15. The system of claim 8, wherein the recipient identifier comprises information insufficient to transmit the item of content to a recipient device.

16. The system of claim 8, wherein the delivery information comprises an e-mail address, a telephone number, account information for a social media platform, or combinations thereof.

17. The system of claim 8, wherein the unique redemption code comprises an alphanumeric string.

18. The system of claim 17, wherein the alphanumeric string comprises a portion that directly corresponds to the recipient identifier, an identifier of a sender, or combinations thereof.

19. A computer-implemented method for asynchronously delivering content to a recipient, the method comprising:
at a first time:
receiving, from a sender device, a recipient identifier, a first item of content, and a first delivery time period;
generating a unique redemption code associated with the recipient identifier;
storing, in a non-transitory data storage medium, the first item of content, the recipient identifier, and the first delivery time period in association with the unique redemption code;
transmitting the unique redemption code to the sending device;
at a second time later than the first time:
receiving, from the recipient device, the unique redemption code;
transmitting a request for delivery information to the recipient device;
receiving delivery information from the recipient device and storing the delivery information in the non-transitory data storage medium in association with the recipient identifier;
transmitting, to the sending device, a notification of receipt of the unique redemption code and initiating a cancellation time period;
initiating a delivery schedule if a cancellation request is not received from the sending device prior to expiration of the cancellation time period, wherein initiating the delivery schedule comprises:
initiating the first delivery time period; and
transmitting, to the recipient device, the first item of content after expiration of the first delivery time period.

20. The method of claim 19, further comprising:
receiving, from the sender device, a second item of content and a second delivery time period; and
storing, in the non-transitory data storage medium, the second item of content and the second delivery time period in association with the unique redemption code,
wherein initiating the delivery schedule further comprises:
initiating the second delivery time period; and
transmitting, to the recipient device, the second item of content after expiration of the second delivery time period.
